(19) United States
(12) Patent Application Publication
(10) Pub. No.: US 2017/0103635 A1
(43) Pub. Date: Apr. 13, 2017

(54) PROXIMITY ALARM BAND SYSTEM

(71) Applicants: Dorothy Kroll, Dorr, MI (US); Larry Kroll, Dorr, MI (US)

(72) Inventors: Dorothy Kroll, Dorr, MI (US); Larry Kroll, Dorr, MI (US)

(21) Appl. No.: 14/877,093

(22) Filed: Oct. 7, 2015

(51) Int. Cl. G08B 21/02

(52) U.S. Cl. CPC G08B 21/0261

(57) ABSTRACT

A proximity alert system comprising: a first wrist band; a second wrist band; a receiver on the first wrist band; a transmitter on the second wrist band, where the transmitter transmits a signal to the receiver; a predetermined received signal strength setting on the first wrist band; and an alarm incorporated into the receiver, where the alarm is activated when the received signal strength drops below the received signal strength setting. The alarm preferably includes an audio alarm and/or a visual alert. In one particular embodiment, the signal is a RF signal.

### BACKGROUND OF THE INVENTION

Field of Invention

The present invention relates to a proximity alarm band system that is used in a pair for alerting users of location.

Description of Related Art

Individuals often must keep track of their children or in certain instances elderly relatives when accompanying them in public. Many times children or elderly persons may wander off and become lost after drifting away from their caregiver or parent. This issue is a common occurrence due to the many tasks that individuals must engage in on a daily basis. Many times children are left in a vehicle or an elderly person is allowed to wonder away and becomes completely lost. As a result, it would be advantageous to have a wrist band system that included proximity alarms notifying users of movement of a child or elderly person outside a given range or predetermined range or distance.

### SUMMARY OF THE INVENTION

The present invention relates to a proximity alert system comprising: a first wrist band; a second wrist band; a receiver on the first wrist band; a transmitter on the second wrist band, where the transmitter transmits a signal to the receiver; a predetermined received signal strength setting on the first wrist band; and an alarm incorporated into the receiver, where the alarm is activated when the received signal strength drops below the received signal strength setting. The alarm preferably includes an audio alarm and/or a visual alert. In one particular embodiment, the signal is a RF signal.

### BRIEF DESCRIPTION OF DRAWINGS

FIG. 1 depicts proximity alarm bands in accordance with the present invention.

### DETAILED DESCRIPTION

The present invention relates to an alarm band system that is used as a proximity alert system. The proximity alarm system according to the present invention includes two bands that are used in conjunction. The bands include a RF signal or other radio frequency implanted within each band's circuitry. The circuitry detects signals from the adjoining or paired band and approximates the distance between the bands on a continuous basis. Should the distance between the bands increase beyond a predetermined distance then a alarm or alert is triggered on the band in particular a caregiver's band alerting the caregiver that the adjoining band or connected band is outside of a certain predetermined range. Preferably, one band of the paired bands is indicated as the caregiver band and the second band is for use on a child or an elderly person as the care receiver.

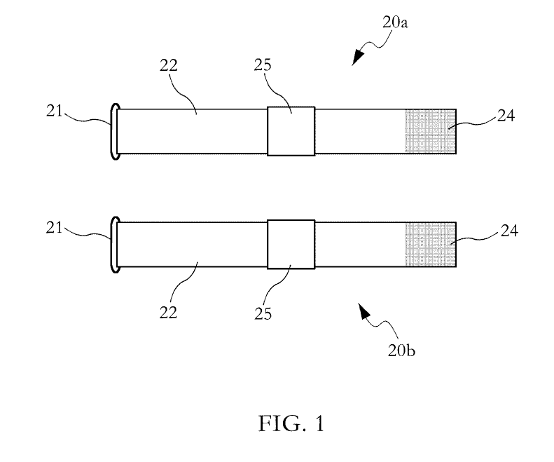

In reference to FIG. 1, a First Alert Band 20a is depicted. Alert Band 20a includes a Clasp 21 at a first end and a hook and loop connector 24 at the opposite end of the band 20a. During use, the user loops Strap 22 through the Clasp 21, the Strap 22 extends over the length of the Alert Band 20a. Once looped with the Clasp 21, a user secures the Band 20a around their wrist by using the Hook and Loop Connector 24 provided at the opposite end of the Band 22. An Electronic Sensor 25 is provided at the center of the Band 22. The Alert Band 20a may serve as a caregiver band in that it receives transmission from a Paired Band 20b shown in FIG. 2. The Band 20b is similarly arranged with similar components, however this band transmits an RF signal for receipt on the receiving or Caregiver Band 20a. This RF signal is set so that a certain signal strength is received by the Receiver 25 on the Caregiver Band 20a. The Care Receiver Band 20b also includes Circuitry 25 that transmits the RF signal to the Receiving Band 20a. Once this signal weakens due to distance between the bands, an alarm or alert is provided on the Caregiver Band 20a alerting the user that the care receiver band has drifted outside the predetermined range as set between the paired bands. This system of proximity alerting helps in maintaining the location of a child or elderly person who is receiving care from a caregiver.

In one alternative embodiment of the present invention, the Alert Band 20a is integrated with a smartphone. A suitable application may be implemented into the smartphone for interaction with the Alert Band 20a. Once integrated with the smartphone, a user may receive alerts related to the use of the Alert Band 20a with the Paired Band 20b. Further a tracking capability may be further implemented as a feature of the application. A user equipped with the Alert Band 20a therefore may be able to track and find the user of the Paired Band 20b through the assistance of the smartphone application. The instant invention has been shown and described in what it considers to be the most practical and preferred embodiments. It is recognized, however, that departures may be made there from within the scope of the invention and that obvious modifications will occur to a person skilled in the art.

What is claimed is:

1. A proximity alert system comprising:
a. a first wrist band;
b. a second wrist band;
c. a receiver on the first wrist band;
d. a transmitter on the second wrist band, where the transmitter transmits a signal to the receiver;
e. a predetermined received signal strength setting on the first wrist band; and
f. an alarm incorporated into the receiver, where the alarm is activated when the received signal strength drops below the received signal strength setting.

2. The proximity alert system according to claim 1, where the alarm includes an audio alarm.

3. The proximity alert system according to claim 1, where the alarm includes a visual alert.

4. The proximity alert system according to claim 1, where the signal is a RF signal.

5. The proximity alert system according to claim 1, further including blue tooth connectivity on the first wrist band enabling the first wrist band to connect with a smartphone.

6. The proximity alert system according to claim 2, where the smartphone includes a software application the provides notices and regarding the functionality of the proximity alert system.
